(19) United States
(12) Patent Application Publication
(10) Pub. No.: US 2006/0290962 A1
(43) Pub. Date: Dec. 28, 2006

(54) Printer/copier having universal pointing device interface

(75) Inventors: Dean Lynn, Ware (GB); Thomas Chase, Welwyn Garden City (GB); Andy Jordan, Harpenden (GB); Tomas Bystrom, Highgate (GB); Satyan Vadher, Wembley (GB)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: XEROX CORPORATION

(21) Appl. No.: 11/166,389

(22) Filed: Jun. 24, 2005

(51) Int. Cl. G06F 3/12

(52) U.S. Cl. 358/1.13

(57) ABSTRACT

What is disclosed is a printer/copier having a Universal Pointing Device Interface (UPDI) for accepting a variety of different pointing devices. The UPDI includes a connector for connecting to a pointing device and a controller having a cursor movement controller for receiving cursor moving signals from the pointing device and moving the cursor on the screen in accordance therewith. The UPDI also includes a Graphic User Interface (GUI) image selection controller for selecting GUI images pointed to by the cursor for actuation upon receiving selection signals from the pointing device. The printer/copier also includes cursor-selectable GUI images displayed on the screen for actuation by the cursor. The cursor-selectable GUI images correspond to the direct-touch buttons disposed on the machine for initiating similar printer/copier functions or inputting similar information via a pointing device.

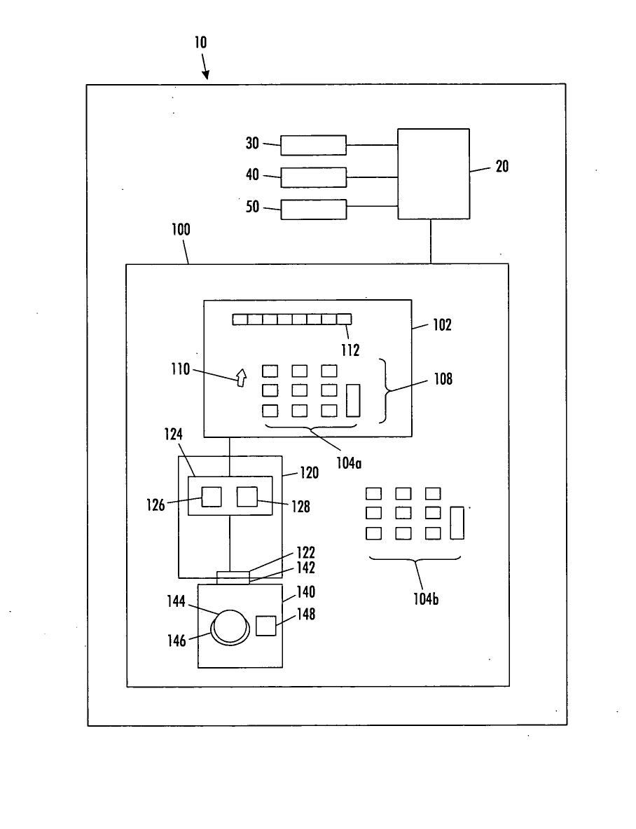

### CROSS REFERENCE TO RELATED PATENTS AND APPLICATIONS

The present application is related to U.S. patent application Ser. No. 10/342,874, filed Jan. 15, 2003.

### INCORPORATION BY REFERENCE

U.S. patent application Ser. No. 10/342,874, filed Jan. 15, 2003, is hereby incorporated herein, in its entirety, by reference.

### BACKGROUND

Illustrated herein are embodiments of a printer/copier having a flexible User Interface suitable for use by users having disabilities affecting the movement of their hands and/or fingers. The embodiments disclosed herein find particular application in conjunction with printer/copiers having an interface accommodating interchangeable pointing devices and will be described with particular reference thereto. However, it is to be appreciated that these embodiments are also amenable to other like applications.

Copiers capable of copying documents are widely used at both the home and workplace. Similarly, printers capable of forming hardcopy images are also in wide use today. Multifunction machines often combine the functionality of printers and copiers and perhaps other machines including but not limited to fax machines, and scanners and the like.

Printer/copiers, which can be printers, copiers or multifunction machines typically include a User Interface located on these machines which enables the user to operate them. The User Interface typically includes buttons which the user pushes for selecting desired machine functions or inputting information, such as the number of copies desired. Accompanying these hard keys will typically be a screen which will display the current options to the user, this screen may also be able to respond to touch in order to select/confirm options. The GUI will typically display advanced options for programming copy/print jobs, e.g. stapled output selection, output paper size etc, the basic functions i.e. keypad entry for number of copies required and the “Start Job” button being provided by hard keys.

Although a wide variety of different User Interfaces are known, these interfaces require a level of manual dexterity which does not accommodate users having disabilities affecting the movement of the hand and fingers to operate them. Disabled persons having limited manual dexterity have trouble pressing the rather small buttons needed for operating these machines. It is desirable to provide printer/copiers that can accommodate those with limited manual dexterity so that they can operate these machines.

### BRIEF DESCRIPTION

A printer/copier having a Universal Pointing Device Interface (UPDI) for accepting a variety of different pointing devices is disclosed. The Universal Pointing Device Interface includes a connector for connecting to a pointing device and a controller. This controller includes two sub systems; the first is responsible for processing cursor moving signals from the pointing device and moving the cursor on the screen in accordance therewith. The second is responsible for selecting graphical user interface (GUI) images, present on screen and pointed to by the cursor for actuation upon receiving selection/activation signals from the pointing device.

The GUI may be enhanced to support the UPDI by providing both the advanced options usually displayed and configured by the touch screen GUI, accompanied by the options provided by hard keys. The UDPI controller, on activation of the interchangeable user interface hardware, can activate this additional content on screen.

Other objects, advantages, and salient features of the invention will become apparent from the detailed description which, taken in conjunction with the drawings, disclose the preferred embodiments of the invention.

### BRIEF DESCRIPTION OF THE DRAWINGS

The preferred embodiment and other aspects of the invention will become apparent from the following detailed description when taken in conjunction with the accompanying drawings which are provided for the purpose of describing the invention and not for the limitation thereof, in which:

THE FIGURE is a block diagram illustrating a printer/copier with a Universal Pointing Device Interface.

### DETAILED DESCRIPTION

With reference to THE FIGURE, there is illustrated an image producing machine, referred to herein as a printer/copier 10, which forms an image on a substrate, such as paper, or the like. The printer/copier 10 can be a copier, or a printer, or a multifunction device which prints and/or copies.

Operation and control of the various subsystems, components and functions of the printer/copier 10 are performed with the aid of a central controller 20. The controller 20 can be a self-contained, dedicated computer or processor. The controller 20 reads, captures, prepares and manages the image data flow between image input sources, such as a scanning system 30, and printheads 40 used for forming the image on the paper. The controller 20 also operates the paper handling system 50 for moving paper through the machine 10 in a controlled manner to receive ink/toner from the printheads/Xerographics (Laser copier) 40 to form the images thereon. As such, the controller 20 is the main multi-tasking processor for operating and controlling machine subsystems and functions.

In operation, image data for an image to be produced is sent to the controller 20 from the scanning system 30, or via a network connection, for processing and output to the printheads 40. Additionally, the controller 20 determines and/or accepts related subsystem and component controls from operator inputs provided by the user via a user interface 100 located at or on the printer/copier 10, and accordingly executes these functions. Examples of these functions can include, but are not limited to, starting a copying job, selecting the paper size to be printed or copied, choosing the number of copies to be made, etc. As a result, images are printed or copied onto the paper in accordance with the commands provided by the user via the User Interface 100.

The User Interface 100 includes a screen 102 suitable for displaying information to the user for operating the machine. In the example provided herein, the screen is a Liquid Crystal Display (LCD), though other screens capable of displaying information are contemplated. The screen 102 can be attached to the housing of the printer/copier 10 as is known in the art.

The User Interface 100 also includes a plurality of direct-touch buttons 104, which provide for the selection and control of the printer/copier functions or the input of information when pressed directly by a user, such as for example by the user's finger. The direct-touch buttons 104 can be known touch screen buttons 104a which are displayed on the screen 102. The user presses the screen 102 with his/her finger to press the touch screen direct-touch buttons 104a. The direct-touch buttons 104 can also be hardbuttons 104b which are stand alone buttons that are physically separated from the screen 102. The user touches the surface of the hardbuttons 104b to press them for selecting and controlling the printer/copier functions as described above.

The User Interface 100 also includes a Graphic User Interface (GUI) 106 displayed on the screen 102. The GUI includes cursor-selectable GUI images 108 resembling the direct-touch buttons 104 in appearance and function as shall be described in further detail below, the GUI's display is not however limited to display only those options available via hard keys, it may also display further advanced options. A cursor 110 is displayable on the screen 102 for selecting the GUI images for actuation.

The User Interface 100 also includes a Universal Pointing Device Interface (UPDI) 120 capable of accepting a plurality of different pointing devices, one of which is shown at 140, for connection thereto. The pointing device interface 120 includes an electrical connector 122 for providing an electrical connection between the pointing device 140 and the printer/copier 10. The connector 122 can be a Universal Serial Bus (USB) connector, or another known connector and bus, for receiving control signals from the pointing device as shall be described in further detail below.

The UPDI 120 also includes a controller 124, which may be hardware or a software module depending on the form of connection used, for receiving control signals from the pointing device 140 for controlling the cursor 110 on the screen 102. The controller 124 includes a cursor movement controller 126 for receiving cursor moving signals from the pointing device 140 and moving the cursor 110 on the screen 102 in accordance therewith. The controller 124 also includes a GUI image 108 selection controller 128 for receiving selection signals from the pointing device and selecting GUI images for actuation pointed to by the cursor.

The UPDI can enable the pointing device 140 to be “hot swappable” such that it can be connected and disconnected while the printer/copier is running and is automatically recognized by the controller when connected. As a result, one pointing device 140 can be disconnected from the UPDI 120 and another pointing device can be connected without having to power down the printer/copier 10. Examples of hot swappable pointing devices and associated interfaces using the USB interface on computers, such as laptop and desktop computers, are well known in the art.

The User Interface 100 also includes a pointing device 140 suitable for manipulation by persons having a disability which limits their manual dexterity connected to the UPDI 120. A trackball 140 is described herein for the purposes of example, however, it should be appreciated that other suitable known pointing devices can be connected to the UPDI 120 to enable persons with disabilities to operate the printer/copier 10, including but not limited to a joystick.

The trackball pointing device 140 includes an electrical connector 142 for connecting to the UPDI connector 122 for passing signals to the UPDI controller 124. In this example, the connector 142 is a USB connector suitable for connecting to the UPDI USB connector 122. The pointing device 140 also includes a cursor moving actuator 144 for generating cursor moving signals. In this example, the trackball cursor moving actuator is a ball 144 captured in a cradle 146 which enables the ball to be rotated without leaving the cradle. Sensors (not shown) are coupled to the ball 144 in a known manner for generating the cursor moving signals when the ball is moved by a user. The cursor moving signals are similar to the cursor moving signals created by a computer mouse and are well known in the industry. The cursor moving signals are sent to the cursor movement controller 126 which converts the cursor moving signals into graphics signals suitable for moving the cursor 110 around the GUI 106 in a known manner. The cursor movement controller 126 can be part of a software driver, similar to known mouse drivers, which are well known in the industry. Persons having little or no manual dexterity can move the ball 144 to control the movement of the cursor 110 on the GUI 106 for pointing to desired GUI images 108.

The pointing device 140 also includes a selection actuator 148 for providing selection signals when actuated. In this example, the selection actuator is a rather large button 148 disposed adjacent the trackball 146. The button 148 can be formed of a soft material, such as for example rubber, to enable persons with little or no manual dexterity to press it for generating the selection signals. Sensors, such as a switch (not shown) are coupled to the selection actuator button 148 for generating the selection signals in a known manner. The selection signals are similar to the selection signals created by a computer mouse having a button for clicking on a GUI image pointed to by a cursor, and are well known in the industry. The selection signals are transmitted to the GUI image selection controller 128 for selecting GUI images for actuation that are pointed to by the cursor 110. The GUI image selection controller 128 can be part of a software driver, similar to known mouse drivers, which are well known in the industry.

The UPDI 120 enables different, interchangeable pointing devices 140 to be connected to the printer/copier 10 for assisting disabled persons in operating the printer/copier. The interchangeable pointing devices 140 will all have a cursor moving actuator 144 for creating cursor moving signals when moved and a selection actuator 148 for providing selection signals when actuated. Different pointing devices 140 can be connected to the UPDI 120 to assist persons with wide ranges physical handicaps. Each pointing device 140 will have a cursor moving actuator 144 and selector actuator 148 tailored to the specific needs of the disabled printer/copier operator so as to provide the easiest movement with the best control can be used.

In operation, the user moves the cursor moving actuator 144 creating a cursor moving signal. The controller 124 receives the cursor moving signal and displays a cursor 110 on the screen 102. Upon receiving the cursor moving signals, the controller 124 displays GUI images 108 which appear similar to the direct-touch buttons 104a, 104b. The GUI images 108 look like the direct-touch buttons 104, having similar shapes and a similar layout and arrangement. The GUI images 108 therefore correspond to the direct-touch buttons 104, with each GUI image initiating a printer/copier function or inputting information similar to their corresponding direct-touch button. However, the GUI images 108 are actuated by pointing the cursor 110 at them and selecting them using the pointing device 140, rather than by pressing them with a like the direct-touch buttons 104. The GUI images 108 provide another manner of actuating the printer/copier functions initiated by the direct-touch buttons 104.

The operator moves the cursor 110 on the screen by moving the cursor moving actuator 144 until the cursor points to the desired GUI image. The GUI images 108 is then selected by pressing the selection actuator button 148 to initiate the printer/copier function or input the information that the corresponding direct-touch button does when pressed. In this manner, the disabled person can use the pointing device 140 to operate the printer/copier 10 in a manner similar to operators using the direct-touch buttons 104. The GUI 106 can also include menus offering more GUI images 112, including icons, toolbars, etc., which can provide more choices for controlling the printer/copier 10 via the pointing device 140.

Providing control of the printer/copier operation via the direct-touch buttons 104, and the many advanced options that are possible via normal GUI touch screen operation, enables quick and efficient operation for those operators having sufficient manual dexterity to actuate them. The inclusion of the Universal Pointing Device Interface 120 which uses a GUI having cursor-actuated GUI images simulating the look and function of the direct-touch buttons 104 also enables persons with little or no manual dexterity to operate the printer/copier. The UPDI 120 accommodates different pointing devices, each of which can be tailored to the physical needs of disabled operators.

While the invention is described with reference to a particular embodiment, this particular embodiment is intended to be illustrative, not limiting. Various modifications may be made without departing from the spirit and scope of the invention as defined in the amended claims. Modifications and alterations will occur to others upon reading and understanding this specification; therefore, it is intended that all such modifications and alterations are included insofar as they come within the scope of the appended claims or equivalents thereof.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A printer/copier comprising:
direct-touch buttons for selecting printer/copier functions or inputting information when pressed by a user;
a screen for displaying information to a user;
a Graphic User Interface (GUI) having images displayable on the screen;
a cursor displayable on the screen; and
a pointing device interface capable of accepting a plurality of different pointing devices for connection thereto, the pointing device interface including a connector for connecting to a pointing device and a controller having a cursor movement controller for receiving cursor moving signals from the pointing device and moving the cursor on the screen in accordance therewith and a GUI image selection controller for selecting GUI images pointed to by the cursor for actuation upon receiving selection signals from the pointing device.

2. The printer/copier defined in claim 1 further comprising a pointing device having a connector for connecting to the pointing device interface, a cursor mover for providing cursor moving signals to the pointing device interface for moving the cursor on the screen and an actuator for providing selection signals to the pointing device interface for selecting GUI images pointed to by the cursor.

3. The printer/copier defined in claim 1 wherein the pointing device interface is a hot swappable interface.

4. The printer/copier defined in claim 1 wherein the controller displays the cursor on the screen upon receiving the cursor moving signal and terminates the display of the cursor after a time period of receiving no cursor moving signal.

5. The printer/copier defined in claim 1 further comprising cursor-selectable GUI images displayed on the screen for actuation by the cursor, the cursor-selectable GUI images corresponding to the direct-touch buttons for initiating similar printer/copier functions or inputting similar information.

6. The printer/copier defined in claim 1 wherein the pointing device is a trackball device such that the cursor mover is a trackball and the actuator is a hard button.

7. A printer/copier comprising:
direct-touch buttons for selecting printer/copier functions or inputting information when pressed by a user;
a screen for displaying information to a user;
a cursor displayable on the screen;
a Graphic User Interface (GUI) having cursor-selectable GUI images displayable on the screen, the GUI images corresponding to the direct-touch buttons for selecting similar printer/copier functions or inputting similar information when selected by the cursor; and
a pointing device interface capable of accepting a plurality of different pointing devices for connection thereto, the pointing device interface including a connector for connecting to a pointing device and a controller having a cursor movement controller for receiving cursor moving signals from the pointing device and moving the cursor on the screen in accordance therewith and a GUI image selection controller for selecting GUI images pointed to by the cursor for actuation upon receiving selection signals from the pointing device.

8. The printer/copier defined in claim 7 further comprising a pointing device having a connector for connecting to the pointing device interface, a cursor mover for providing cursor moving signals to the pointing device interface for moving the cursor on the screen and an actuator for providing selection signals to the pointing device interface for selecting GUI images pointed to by the cursor.
